(19) United States
(12) Patent Application Publication
(10) Pub. No.: US 2025/0342327 A1
(43) Pub. Date: Nov. 6, 2025

(54) SYSTEM AND METHOD TO DETERMINE RADIO FREQUENCY IDENTIFICATION (RFID) TAGS

(71) Applicant: Hand Held Products, Inc., Charlotte, NC (US)

(72) Inventors: Shashidhar RAMAMURTHY, Charlotte, NC (US); Donald JOHNSON, Charlotte, NC (US); Abhishek MATHUR, Charlotte, NC (US); Shyam Kumar GORNAKONDA, Charlotte, NC (US)

(21) Appl. No.: 19/180,856

(22) Filed: Apr. 16, 2025

(30) Foreign Application Priority Data
May 2, 2024 (IN) 202411034868

(51) Int. Cl. G06K 7/10

(52) U.S. Cl. CPC G06K 7/10128; G06K 7/10217

(57) ABSTRACT

A system comprises a radio frequency identification (RFID) reader, a presence detector, and at least one processor operationally coupled to the RFID reader and the presence detector. The at least one processor determines, whether a RFID tag and a RFID tag read time are identified; determine, via the presence detector, a last movement time period; determines whether the RFID tag read time is within the last movement time period; determines whether the RFID tag is on a tag list and update the RFID tag to a tag list when the RFID tag read time is within or not within the last movement time period and RFID tag is on the tag list, or add the RFID tag to a stray list when the RFID tag read time is within or not within the last movement time period and the RFID tag is not on tag list.

### CROSS-REFERENCE TO RELATED APPLICATION

This application claims priority pursuant to 35 U.S.C. 119 (a) to Indian Application No. 202411034868, filed May 2, 2024, which application is incorporated herein by reference in its entirety.

### TECHNOLOGICAL FIELD

Example embodiments of the present disclosure relate generally to radio frequency identification (RFID) systems and more particularly, to a system and a method to determine RFID tags.

### BACKGROUND

Radio frequency identification (RFID) readers may be used for monitoring multiple packages within a confined space such as warehouses or storage facilities. RFID readers use radio-frequency identification techniques for reading the RFID tags. RFID readers may be used to monitor packages going in or out of zones or confined spaces. However, in many instances, the packages that do not belong to a particular zone or confined space may be incorrectly detected by an RFID reader.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a summary of some example embodiments to provide a basic understanding of some aspects of the present disclosure. This summary is not an extensive overview and is intended to neither identify key or critical elements nor delineate the scope of such elements. It will also be appreciated that the scope of the disclosure encompasses many potential embodiments in addition to those here summarized, some of which will be further described in the detailed description that is presented later.

In an example embodiment, a system is disclosed. The system comprises a radio frequency identification (RFID) reader, a presence detector communicatively coupled with the RFID reader, and at least one processor operationally coupled to the RFID reader and the presence detector. Further, the at least one processor is configured to determine via the RFID reader, whether a RFID tag and a RFID tag read time are identified; determine, via the presence detector, a last movement time period associated with the RFID tag on identifying the RFID tag and the RFID tag read time; determine whether the RFID tag read time is within the last movement time period associated with the RFID tag; determine whether the RFID tag is on a tag list; update the tag list based at least on the RFID tag when the RFID tag read time is within the last movement time period associated with the RFID tag and the RFID tag is on the tag list; add the RFID tag to the tag list when the RFID tag read time is within the last movement time period associated with the RFID tag and the RFID tag is not on the tag list; update the RFID tag to the tag list when the RFID tag read time is not within the last movement time period associated with the RFID tag and the RFID tag is on the tag list; add the RFID tag to a stray list when the RFID tag read time is not within the last movement time period associated with the RFID tag and the RFID tag is not on the tag list.

In some embodiments, the last movement time period comprises a last read time of the RFID tag. In some embodiments, the system further comprises the plurality of reference RFID tags calibrated with the RFID reader. The at least one processor is configured to determine radio frequency (RF) power at a channel associated with one of the plurality of RFID tags and to set a calibration time period. In some embodiments, the RFID reader is configured to read the RFID tag with the determined RF power at the channel to identify the RFID tag and the RFID tag read time.

In some embodiments, when the RFID tag read is not identified, the at least one processor is further configured to determine whether the dwell time period is expired. Further, the dwell time period corresponds to a time period for reading the RFID tag by the RFID reader. In some embodiments, upon determining the dwell time period expired, the at least one processor is further configured to switch the RFID reader on to another channel and reset the dwell time period, and upon determining the dwell time period not expired, the RFID reader is further configured to read the RFID tag with the determined radio frequency (RF) power at the channel.

In some embodiments, the channel comprises at least one of an ultra-high frequency (UHF) channel, a low frequency (LF) channel, or a very high frequency (VHF) channel. In some embodiments, the presence detector comprises at least one of an infrared (IR) sensor, millimeter (MM) wave sensor, microwave sensor, accelerometer, gyroscope, or radar sensor. In some embodiments, the at least one processor is further configured to determine whether the calibration time period is expired. Further, upon determining the calibration time period is expired, the at least one processor is further configured to re-calibrate the RFID reader to determine radio frequency (RF) power. In some embodiments, upon determining the calibration time period is not expired, the RFID reader is configured to read another RFID tag with the determined RF power at the channel.

In another example embodiment, a method is disclosed. The method comprises steps of determining, via a RFID reader, whether a RFID tag and a RFID tag read time are identified. Further, the method comprises steps of determining, via a presence detector, a last movement time period associated with the RFID tag on identifying the RFID tag and the RFID tag read time; determining, via at least one processor, whether the RFID tag read time is within the last movement time period of the RFID tag; determining, via the at least one processor, whether the RFID tag is on a tag list.

In some embodiments, the method further comprises steps of updating, via the at least one processor, the tag list based at least on the RFID tag when the RFID tag read time is within the last movement time period of the RFID tag and the RFID tag is on the tag list; adding, via the at least one processor, the RFID tag to the tag list when the RFID tag read time is within the last movement time period of the RFID tag and the RFID tag is not on the tag list; updating, via the at least one processor, the RFID tag to the tag list when the RFID tag read time is not within the last movement time period of the RFID tag and the RFID tag is on the tag list; and adding, via the least one processor, the RFID tag to a stray list when the RFID tag read time is not within the last movement time period of the RFID tag and the RFID tag is not on the tag list.

The above summary is provided for the purpose of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a block diagram of a system to determine zonal radio frequency identification (RFID) tags in accordance with an example embodiment of the present disclosure;

FIG. 2 illustrates an isometric view of a container installed with the system in accordance with the example embodiment of the present disclosure; and,

FIG. 3 illustrates a flow chart of a method in accordance with an example embodiment of the present disclosure.

### DETAILED DESCRIPTION

Some embodiments will now be described more fully hereinafter with reference to the accompanying drawings, in which some, but not all, embodiments of the present disclosure are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The present disclosure provides various embodiments of systems and methods to enhance the working of an RFID reader. Embodiments may calibrate the RFID reader to read an RFID tag with radio a frequency (RF) power at a particular channel. Embodiments may determine a last movement time period and RFID tag read time associated with the RFID tag. Embodiments may add or update the RFID tag on the tag list based on at least one determined last movement time period and the RFID tag read time. Embodiments may add or update the RFID tag on the stray list based at least one the determined last movement time period and the RFID tag read time. Embodiments may enable the RFID reader to read the RFID tag within a confined space.

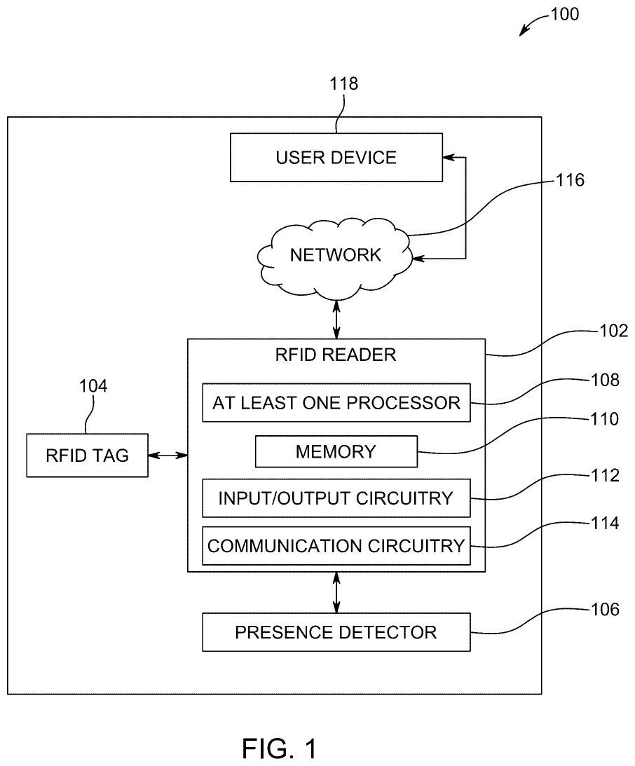

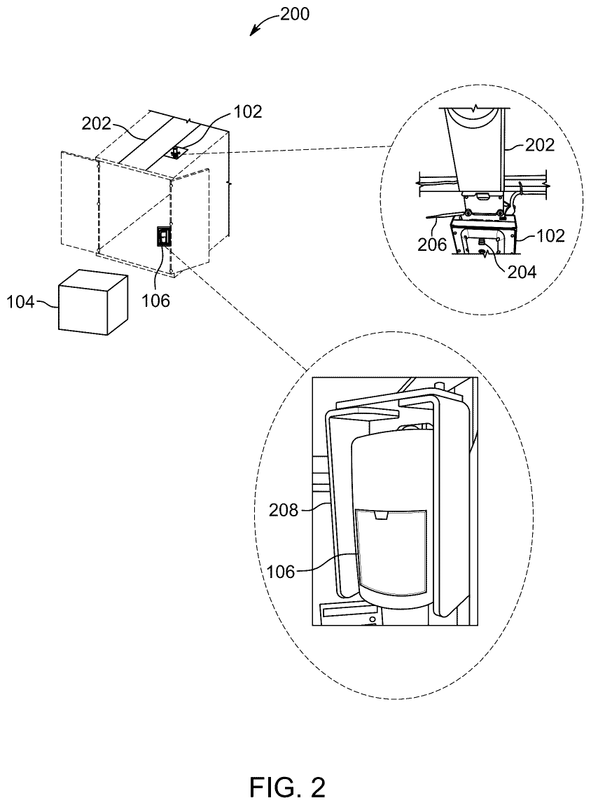

FIG. 1 illustrates a block diagram of a system 100 to determine radio frequency identification (RFID) tags, in accordance with an example embodiment of the present disclosure. FIG. 2 illustrates an isometric view of a container 200 installed with the system 100, in accordance with the example embodiment of the present disclosure.

In some embodiments, the system 100 may comprise a radio frequency identification (RFID) reader 102, a RFID tag 104, a presence detector 106, and at least one processor 108. In some embodiments, the RFID reader 102 may be configured to communicate with the RFID tag 104 present in proximity to the RFID reader 102. Further, the RFID reader 102 may be configured to communicate with the RFID tag 104 present inside a predefined threshold distance range X meters.

As illustrated herein, the RFID reader 102 may be installed inside the container 200 having a confined space. In some embodiments, a plurality of supporting brackets 202 may be affixed inside the container 200 configured to install the RFID reader 102 inside the container 200. The plurality of supporting brackets 202 may be installed at a ceiling (not shown) of the container 200 (as shown in FIG. 2) to maximize field of view (FOV) of the RFID reader 102. In some embodiments, the RFID reader 102 may be installed with at least one light emitting diode (LED) 204. Further, the at least one LED 204 may be configured to indicate the activity status of the RFID reader 102.

In some embodiments, the RFID reader 102 may be configured to emit one or more radio-frequency signals to communicate with the RFID tag 104 present in proximity to the container 200 or inside the container 200. In some embodiments, the RFID reader 102 may be installed with at least one antenna module 206. In some embodiments, the RFID reader 102 may be configured to emit one or more radio-frequency signals through the at least one antenna module 206 to communicate with the RFID tag 104.

In some embodiments, the RFID tag 104 may be configured to store encoded information. In some embodiments, the RFID tag 104 may be installed with an antenna (not shown). Further, the antenna may be configured to enable the RFID tag 104 to communicate with the RFID reader 102 through the one or more radio-frequency signals emitted by the RFID reader 102. In some embodiments, the RFID tag 104 may correspond to at least one passive RFID tag or active RFID tag.

In one example embodiment, the RFID reader 102 may communicate with a passive RFID tag (not shown). The passive RFID tag may be configured to draw power from the one or more radio-frequency signals received from the RFID reader 102. In another example embodiment, the RFID reader 102 may communicate with an active RFID tag. The active RFID tag may comprise at least one power source. The at least one power source may be configured to activate the active RFID tag and allow communication of the RFID tag with the RFID reader 102 through the one or more radio-frequency signals.

In some embodiments, the system 100 may further comprise a plurality of reference RFID tags. In some embodiments, the plurality of reference RFID tags may be configured to calibrate the RFID reader 102 to determine radio frequency (RF) power at a channel. Further, the plurality of reference RFID tags may be configured to calibrate the RFID reader 102 to set a calibration time period. In some embodiments, the plurality of reference RFID tags may correspond to plurality of passive/active RFID tags encoded with data required to calibrate the RFID reader 102 to determine the RF power at the channel. In some embodiments, the channel may comprise at least one of an ultra-high frequency (UHF) channel, a low frequency (LF) channel, or a very high frequency (VHF) channel.

In some embodiments, the RFID reader 102 may be configured to read the RFID tag 104 with the determined RF power at the channel to identify the RFID tag 104 and the RFID tag read time. In one example embodiment, the RFID reader 102 may be calibrated to identify the RFID tag 104 and the RFID tag read time, with determined RF power at the ultra-high frequency (UHF) channel. Further, in another case, the RFID reader 102 may be calibrated to read the RFID tag 104 and the RFID tag read time, with determined RF power at the low frequency (LF) channel. Further, in yet another case, the RFID reader 102 may be calibrated to read the RFID tag 104 and the RFID tag read time, with determined RF power at the very-high frequency (VHF) channel.

In some embodiments, the RFID reader 102 may be configured to register a dwell time period while reading the RFID tag 104. In some embodiments, the dwell time period may correspond to a time period for reading the RFID tag 104 by the RFID reader 102. In some embodiments, the dwell time period may depend upon one or more factors. The one or more factors may comprise at least one of distance between the RFID tag 104 and the RFID reader 102, type of the RFID tag 104 (passive RFID tag or active RFID tag) and a frequency channel (low frequency (LF) channel, ultra-high frequency (UHF) channel or any other frequency channel known in the art) at which the RFID reader 102 is calibrated.

As illustrated herein, the RFID reader 102 may be communicatively coupled with the presence detector 106. In some embodiments, the presence detector 106 may be installed inside the container 200. In some embodiments, the present detector 106 may be protected by at least one covering member 208. Further, the at least one covering member 208 may be configured to prevent any degradation in physical properties of the presence detector 106 from a plurality of environmental factors.

In some embodiments, the presence detector 106 may be configured to detect presence of the package or a person carrying the package that has the RFID tag 104. Further, the presence detector 106 may comprise at least one of an infra-red (IR) sensor, millimeter (MM) wave sensor, microwave sensor, accelerometer, gyroscope or radar sensor. In some embodiments, the presence detector 106 may correspond to the IR sensor. Further, the presence detector 106 may be configured to emit one or more infra-red (IR) signals towards the package or the person in a field of view (FOV). The one or more IR signals may strike the package or the person and may reflect back to the presence detector 106. In some embodiments, based at least on variation in the wavelength and intensity of one or more received signals, the presence detector 106 may be configured to determine presence of the package or the person having the package that has the RFID tag 104 in the FOV.

In some alternative embodiments, the presence detector 106 may correspond to the millimeter wave sensor. The presence detector 106 may be configured to emit one or more high frequency wave signals towards the package or the person having the package in the FOV. Further, the one or more high frequency wave signals may strike on the package or the person and may reflect back to the presence detector 106. In some embodiments, based at least on variations in the wavelength of the received one or more high frequency wave signals, the presence detector 106 may be configured to determine presence of the package or the person carrying the package having the RFID tag 104 in the FOV. In an example embodiment, the presence detector 106 may also correspond to an accelerometer, gyroscope, radar sensor or any other presence detectors 106 known in the art.

In some embodiments, the at least one processor 108 may be operationally coupled with the RFID reader 102 and the presence detector 106. In some embodiments, the at least one processors 108 may include suitable logic, circuitry, and/or interfaces that are operable to execute one or more instructions stored in a memory 110 to perform predetermined operations. In some embodiments, the at least one processor 108 may be configured to decode and execute any instructions received from one or more other electronic devices or server(s). The at least one processor 108 may be configured to execute one or more computer-readable program instructions, such as program instructions to carry out any of the functions described in this description. Further, the at least one processor 108 may be implemented using one or more processor technologies known in the art. Examples of the at least one processor 108 include, but are not limited to, one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor).

In some embodiments, the memory 110 may store a set of instructions and data. In some embodiments, the memory 110 may include the one or more instructions that are executable by the at least one processor 108 to perform specific operations. It is apparent to a person with ordinary skill in the art that the one or more instructions stored in the memory 110 enable the hardware of the system 100 to perform predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

In some embodiments, the at least one processor 108 may be configured to receive data from the RFID reader 102. In some embodiments, the received data may correspond to results registered by the RFID reader 102 while identifying the RFID tag 104. Further, the at least one processor 108 may be configured to determine whether the RFID tag 104 and the RFID tag read time are identified by means of the data received from the RFID reader 102.

In one example embodiments, when the RFID tag 104 is not identified by the RFID reader 102, the at least one processor 108 may be configured to fetch from the memory 110 the registered dwell time period from the RFID reader 102. In some embodiments, the at least one processor 108 may be configured to compare the fetched dwell time period with a predefined threshold time period. Further, the pre-defined threshold time period may correspond to Y seconds. In some embodiments, based at least on the comparison, the at least one processor 108 determines whether the dwell time period is expired. In some embodiments, the dwell time period may correspond to the time period for reading the RFID tag 104 by the RFID reader 102.

In one instance, upon determining the dwell time period is expired and the RFID tag 104 is not identified, the at least one processor 108 may be configured to switch the RFID reader 102 on to another frequency channel. Further, the another frequency channel may comprise at least one of the ultra-high frequency (UHF) channel, low frequency (LF) channel, or very high frequency (VHF) channel. In some embodiments, upon switching the RFID reader 102 on another frequency channel, the at least one processor 108 may be configured to reset the dwell time period. In another instance, upon determining the dwell time period is not expired when the RFID tag 104 is not identified, the at least one processor 108 may operate the RFID reader 102 to again read the RFID tag 104 with the determined radio frequency (RF) power at the calibrated channel.

In another embodiment, when the RFID tag 104 is identified, the at least one processor 108 may be configured to determine a last movement time period associated with the RFID tag 104. In some embodiments, the last movement time period may be recorded by the presence detector 106 during the reading of the RFID tag 104 by the RFID reader 102. Further, the at least one processor 108 may be configured to determine the last movement time period on identifying the RFID tag 104 and the RFID tag read time, by the RFID reader 102. In some embodiments, the last movement time period may correspond to last read time of the RFID tag 104.

In some embodiments, the at least one processor 108 may be configured to correlate the determined last movement time period with the RFID tag read time. Further, based on at least one correlation, the at least one processor 108 may determine whether the RFID tag read time is within the last movement time period associated with the RFID tag 104.

In some embodiments, the at least one processor 108 may be configured to determine whether the RFID tag 104 is on a tag list. In an exemplary embodiment, the tag list may be stored inside at least one database (not shown) that may be communicatively coupled with the at least one processor 108. In another exemplary embodiment, the tag list may be stored inside the memory 110. Further, the tag list may comprise a plurality of records corresponding to authorized RFID tags. In some embodiments, the at least one processor 108 may be configured to compare the data received from the RFID reader 102 with the tag list. Further, based at least on the comparison, the at least one processor 108 may determine whether the RFID tag 104 is on the tag list.

In some embodiments, the at least one processor 108 may be configured to encounter one or more cases while correlating one or more parameters received from the RFID reader 102, presence detector 106 and tag list. Further, the one or more parameters may comprise at least one of the RFID tags read time associated with the RFID tag 104, the last movement time period associated with the RFID tag 104, whether the RFID tag 104 is on the tag list, and whether the RFID tag 104 is not on the tag list.

In one example embodiment, upon determining the RFID tag read time associated with the RFID tag 104 is within the last movement time period associated with the RFID tag 104 and the RFID tag 104 is on the tag list. The at least one processor 108 may be configured to update the tag list based at least on the RFID tag 104. In another example embodiment, upon determining the RFID tag read time associated with the RFID tag 104 is within the last movement time period associated with the RFID tag 104 and the RFID tag 104 is not on the tag list. The at least one processor 108 may be configured to add the RFID tag 104 to the tag list.

In one example embodiment, upon determining the RFID tag read time associated with the RFID tag 104 is not within the last movement time period associated with the RFID tag 104 and the RFID tag 104 is on the tag list. The at least one processor 108 may be configured to update the RFID tag 104 to the tag list. In another example embodiment, upon determining the RFID tag read time associated with the RFID tag 104 is not within the last movement time period associated with the RFID tag 104 and the RFID tag 104 is not on the tag list. The at least one processor 108 may be configured to add the RFID tag 104 to a stray list. In an exemplary embodiment, the stray list may be created on the at least one database. In another exemplary embodiment, the stray list may be created on the memory 110. Further, the stray list may be configured to store a plurality of records corresponding to unauthorized RFID tags.

Further, the at least one processor 108 may be configured to determine whether the calibration time is expired. In one example embodiment, upon determining the calibration time is expired, the at least one processor 108 may be configured to re-calibrate the RFID reader 102 to determine the radio frequency (RF) through the plurality of reference RFID tags. In another example embodiment, upon determining the calibration time is not expired, the at least one processor 108 may be configured to direct the RFID reader 102 to read another RFID tag with the determined RF power at the previously calibrated frequency channel.

As illustrated herein, the RFID reader 102 may comprise an input/output circuitry 112 that enables the user to communicate or interface with the RFID reader 102 via a user device 118. The user device 118 may include N number of user devices. It may be noted that the input/output circuitry 112 may act as a medium to transmit input from the user device 118 to and from the RFID reader 102. In some embodiments, the input/output circuitry 112 may refer to the hardware and software components that facilitate the exchange of information between the user and the RFID reader 102. In one example, the user device 118 may include a graphical user interface (GUI) (not shown) as input circuitry to allow the user to input data. The input/output circuitry 112 may include various input devices such as keyboards, barcode scanners, GUI for the user to provide data and various output devices such as displays, printers for the user to receive data.

In some embodiments, the RFID reader 102 may comprise a communication circuitry 114. The communication circuitry 114 may allow the RFID reader 102 and the user device 118 to exchange data or information with other systems or apparatuses. Further, the RFID reader 102 may be communicatively coupled with a network interface 116 via one or more protocols and software modules for sending and receiving data or information. In some embodiments, the communication circuitry 114 may include Ethernet ports, Wi-Fi adapters, or communication protocols like HTTP or MQTT for connecting with other systems. The communication circuitry 114 may allow the RFID reader 102 to stay up to date. In some embodiments, the user device 118 may comprise at least one of one or more mobile phones, laptops, or any other device known in the art.

It will be apparent to one skilled in the art that above-mentioned components of the system 100 have been provided only for illustration purposes, without departing from the scope of the disclosure.

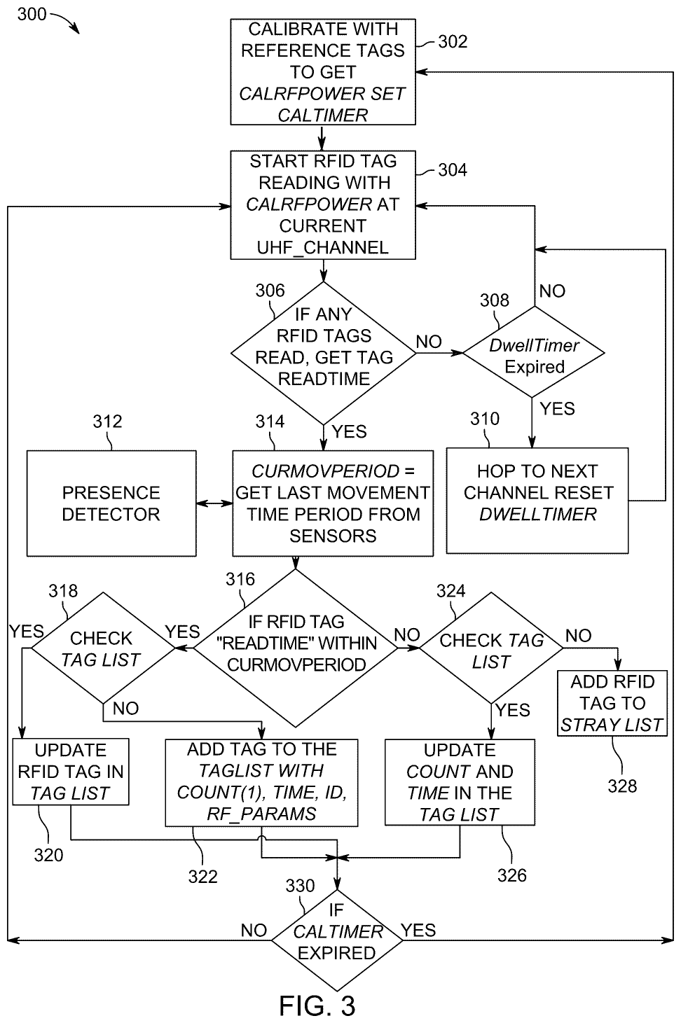

FIG. 3 illustrates a flow chart of a method 300, in accordance with an example embodiment of the present disclosure.

At an operation 302, the RFID reader 102 may be calibrated to determine a radio frequency (RF) power (CALPOWER) of the RFID tag 104 at a channel by a plurality of reference RFID tags. Further, the plurality of reference tags may be configured to set the calibration time period (CALTIMER) of the RFID reader 102 to read the RFID tag 104. For example, the RFID reader 104 of an inventory is first calibrated by one of the plurality of reference RFID tags to determine radio frequency (RF) power (CALRFPOWER) at the ultra-high frequency (UHF) channel.

At an operation 304, the RFID reader 102 may be configured to start reading of the RFID tags 104 with the calibrated RF power (CALRFPOWER) and at the calibrated channel (UHF_CHANNEL). For example, the RFID reader 102 is configured to emit one or more radio frequency signals at the UHF channel, inside the inventory. Further, the one or more emitted radio signals are configured to communicate with the RFID tag 104 at the UHF channel, inside the inventory.

At an operation 306, the at least one processor 108 may be configured to determine whether the RFID tag 104 and the RFID tag read time are identified by the RFID reader 102. In some embodiments, the at least one processor 108 may be operationally coupled with the RFID reader 102 and configured to fetch the RFID tag 104 and the RFID tag read time from the RFID reader 102. For example, the RFID reader 102 may be configured to identify the RFID tag 104 affixed on the package while entering inside the inventory. Further, the RFID reader 102 may be configured to transfer the RFID tag read time to the at least one processor 108.

In one embodiment, the at least one processor 108 upon detecting the RFID tag 104 and the RFID tag read time are not detected by the RFID reader 102, may direct at an operation 308 to check whether the dwell time has expired. In some embodiments, the dwell time period may correspond to a time period for reading the RFID tag 104 by the RFID reader 102. In one aspect, upon determining the dwell time period is not expired, then the RFID reader 102 may be configured to read the RFID tag 104 with the determined radio frequency (RF) power at the channel. For example, the at least one processor 108 may be configured to monitor the dwell time period e.g., 10 seconds of the RFID tag 104 affixed on the package by the RFID reader 102. Further, upon comparing the monitored dwell time period of 10 seconds with a predefined threshold time period of 12 seconds and based at least on the comparison, the at least one processor 108 may determine the dwell time period is not expired.

At an operation 310, in another aspect, upon detecting the dwell time period is expired, the RFID reader 102 may be configured to read the RFID tag 104 determined radio frequency (RF) power at another channel. For example, the at least one processor 108 may be configured to monitor the dwell time period e.g., 14 seconds of the RFID tag 104 affixed on the package by the RFID reader 102. Further, comparing the monitored dwell time period of 14 seconds with a predefined threshold time period of 12 seconds and based at least on the comparison the at least one processor 108 may determine the dwell time period is expired. Further, the another channel may comprise at least one of low frequency (LF) channel, high frequency (HF) channel to enable identification of the RFID tag 104.

At an operation 312, the presence detector 106 may be configured to determine the last movement time period associated with the RFID tag 104 on identifying the RFID tag and the RFID tag read time. In some embodiments, the presence detector 106 may comprise at least one of infra-red (IR) sensor, millimeter (MM) wave sensor, microwave sensor, accelerometer, gyroscope, or radar sensor. For example, the presence detector 106 emits one or more signals towards the package or the person carrying the package. Further, based on variation in the received one or more signals after reflecting, the presence detector 106 determines the last movement time period associated with the RFID tag 104.

At an operation 314, the at least one processor 108 may be configured to receive the last movement time period (CURMOVPERIOD) associated with the RFID tag 104 from the presence detector 106. In some embodiments, the at least one processor 108 may be operationally coupled with the presence detector 106. Further, the last movement time period may correspond to a last read time of the RFID tag 104. For example, the presence detector 106 is installed inside the container 200. The presence detector 106 is configured to determine the last read time associated with the RFID tag 104. The at least one processor 108 is configured to fetch the last movement time period of the RFID tag 104.

At an operation 316, the at least one processor 108 may be configured to compare the last movement time period with the RFID tag read time. In some embodiments, based at least one the comparison, whether the RFID tag read time is within the last movement time period (CURMOVPERIOD) the tag list and the stray list may be updated by the at least one processor 108. For example, upon comparing the last movement time period with the RFID tag read time associated with the RFID tag 104 affixed on the package, the at least one processor 108 determines whether the RFID tag read time is within the last movement time period of the RFID tag 104.

At an operation 318, the at least one processor 108 may be configured to check whether the RFID tag 104 is on the tag list. In some embodiments, upon detecting the RFID tag read time is within the last movement time period, the at least one processor 108 may be configured to compare the RFID tag 104 with a plurality of records stored within the tag list. Further, the plurality of records may correspond to authorized RFID tags. For example, the at least one processor 108 may determine the RFID tag 104 affixed on the package is on the tag list of the inventory.

At an operation 320, the at least one processor 108 may be configured to update the RFID tag 104 in the tag list. In some embodiments, upon determining the RFID tag 104 is on the tag list, the at least one processor may be configured to update the RFID tag 104 in the tag list. For example, the at least one processor 108 may be configured to update the RFID tag 104 of the package on the tag list associated with the inventory when the RFID tag read time associated with the RFID tag 104 of the package is within the last movement time period associated with the RFID tag 104 and the RFID tag 104 of the package is on the tag list.

At an operation 322, the at least one processor 108 may be configured to add the RFID tag 104 in the tag list with COUNT (1), TIME, ID and RF_PARAMS. In some embodiments, upon determining the RFID tag read time associated with the RFID tag 104 is within the last movement time period associated with the RFID tag 104 and the RFID tag 104 is not on the tag list, the at least one processor 108 may be configured to add the RFID tag 104 in the tag list with COUNT (1), TIME, ID and RF_PARAMS. For example, the at least one processor 108 may be configured to add the RFID tag 104 of the package on the tag list associated with the inventory, when the RFID tag read time associated with the RFID tag 104 of the package is within the last movement time period associated with the RFID tag 104 and the RFID tag 104 of the package is not on the tag list.

At an operation 324, the one or more processor 108 may be configured to check the RFID tag 104 in the tag list. In one aspect, upon detecting the RFID tag 104 is in the tag list, the at least one processor may direct at operation 326. In another aspect, upon detecting the RFID tag 104 is not in the tag list, the at least one processor may direct at operation 328. At operation 326, the at least one processor 108 may be configured to update the RFID tag 104 in the tag list with COUNT (1), TIME. For example, the at least one processor 108 may be configured to update the RFID tag 104 of the package on the tag list associated with the inventory when the RFID tag read time associated with the RFID tag 104 of the package is not within the last movement time period associated with the RFID tag 104 of the package and the RFID tag 104 of the package is on the tag list of the inventory.

At an operation 328, the at least one processor 108 may be configured to add the RFID tag 104 in the stray list. In some embodiments, upon determining the RFID tag read time associated with the RFID tag 104 is not within the last movement time period associated with the RFID tag 104 and the RFID tag 104 is not on the tag list, the at least one processor 108 may be configured to add the RFID tag 104 in the stray list. For example, the at least one processor 108 may be configured to add the RFID tag 104 of the package on the stray list of the inventory when the RFID tag 104 of the package is not in the tag list and the RFID read time is not within the last movement time period of the RFID tag 104 of the package.

At an operation 330, the at least one processor 108 may be configured to determine whether the calibration time is expired. In one aspect, upon determining the calibration time is expired, the at least one processor 108 may be configured to recalibrate the RFID reader 102 to determine the radio frequency (RF) through the plurality of reference RFID tags. In another aspect, upon determining the calibration time is not expired, the at least one processor 108 may be configured to activate the RFID reader 102 to read the RFID tag 104 with the determined RF power at the previously calibrated frequency channel.

Embodiments may be configured to enhance working range, efficiency, and precision of the RFID reader 102 for reading a RFID tag 104. Embodiments may improve the readability of the RFID reader 102 by reading the RFID tag 104 present inside the confined space of the container 200. the RFID reader 102 may be configured to identify the RFID tag 104 and the RFID tag read time. The presence detector 106 may provide the last movement time period associated with the RFID tag 104. The at least one processor 108 may be configured to compare the last movement time period associated with the RFID tag 104 and the RFID tag read time. Based at least on a comparison of the last movement time period and the tag read time, the at least one processor 108 adds or updates the RFID tag 104 on the tag list or on the stray list. Embodiments may enhance precision of the RFID reader 102 to read the RFID tag 104 present inside the confined space of the container 200.

Many modifications and other embodiments of the disclosure set forth herein will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system comprising:
a radio frequency identification (RFID) reader;
a presence detector communicatively coupled with the RFID reader; and
at least one processor operationally coupled to the RFID reader and the presence detector, wherein the at least one processor is configured to:
determine, via the RFID reader, whether a RFID tag and a RFID tag read time are identified;
determine, via the presence detector, a last movement time period associated with the RFID tag on identifying the RFID tag and the RFID tag read time;
determine whether the RFID tag read time is within the last movement time period associated with the RFID tag;
determine whether the RFID tag is on a tag list; and,
update, when the RFID tag read time is within the last movement time period associated with the RFID tag and the RFID tag is on the tag list, the tag list based at least on the RFID tag; or
add, when the RFID tag read time is within the last movement time period associated with the RFID tag and the RFID tag is not on the tag list, the RFID tag to the tag list; or
update, when the RFID tag read time is not within the last movement time period associated with the RFID tag and the RFID tag is on the tag list, the RFID tag to the tag list; or
add, when the RFID tag read time is not within the last movement time period associated with the RFID tag and the RFID tag is not on the tag list, the RFID tag to a stray list.

2. The system of claim 1, wherein the last movement time period comprises a last read time of the RFID tag.

3. The system of claim 1 further comprises a plurality of reference RFID tags that are calibrated with the RFID reader, and wherein the at least one processor is further configured to determine radio frequency (RF) power at a channel associated with one of the plurality of RFID tags and to set a calibration time period.

4. The system of claim 3, wherein the RFID reader is configured to read the RFID tag with the determined RF power at the channel to identify the RFID tag and the RFID tag read time.

5. The system of claim 4, wherein when the RFID tag read time is not identified, the at least one processor is further configured to determine whether dwell time period is expired, wherein the dwell time period corresponds to a time period for reading the RFID tag by the RFID reader.

6. The system of claim 5, wherein upon determining the dwell time period expired, the at least one processor is further configured to switch the RFID reader on to another channel and reset the dwell time period, and upon determining the dwell time period not expired, the RFID reader is further configured to read the RFID tag with the determined radio frequency (RF) power at the channel.

7. The system of claim 3, wherein the channel comprises at least one of an ultra-high frequency (UHF) channel, a low frequency (LF) channel, or a very high frequency (VHF) channel.

8. The system of claim 1, wherein the presence detector comprises at least one of infrared (IR) sensor, millimeter (MM) wave sensor, microwave sensor, accelerometer, gyroscope, or radar sensor.

9. The system of claim 3, wherein the at least one processor is further configured to determine whether the calibration time period is expired, wherein upon determining the calibration time period expired, the at least one processor is further configured to re-calibrate the RFID reader to determine radio frequency (RF) power.

10. The system of claim 3, wherein upon determining the calibration time period not expired, the RFID reader is configured to read another RFID tag with the determined RF power at the channel.

11. A method comprising:
determining, via a RFID reader, whether a RFID tag and a RFID tag read time are identified;
determining, via a presence detector, a last movement time period associated with the RFID tag on identifying the RFID tag and the RFID tag read time;
determining, via at least one processor, whether the RFID tag read time is within the last movement time period of the RFID tag;
determining, via the at least one processor, whether the RFID tag is on a tag list; and,
updating, via the at least one processor, when the RFID tag read time is within the last movement time period of the RFID tag and the RFID tag is on the tag list, the tag list based at least on the RFID tag, or
adding, via the at least one processor, when the RFID tag read time is within the last movement time period of the RFID tag and the RFID tag is not on the tag list, the RFID tag to the tag list, or
updating, via the at least one processor, when the RFID tag read time is not within the last movement time period of the RFID tag and the RFID tag is on the tag list, the RFID tag to the tag list, or
adding, via the least one processor, when the RFID tag read time is not within the last movement time period of the RFID tag and the RFID tag is not on the tag list, the RFID tag to a stray list.

12. The method of claim 11, wherein the last movement time period comprising a last read time of the RFID tag.

13. The method of claim 11 further comprising calibrating the RFID reader with a plurality of reference RFID tags.

14. The method of claim 13 further comprising determining radio frequency (RF) power at a channel associated with one of the plurality of RFID tags and setting a calibration time period.

15. The method of claim 14 further comprising reading, via the RFID reader, the RFID tag with the determined RF power at the channel to identify the RFID tag and the RFID tag read time.

16. The method of claim 15 further comprising determining whether dwell time period is expired upon determining the RFID tag read time is not identified, wherein the dwell time period corresponds to a time period for reading the RFID tag by the RFID reader.

17. The method of claim 16 further comprising switching the RFID reader on to another channel and resetting the dwell time period upon determining the dwell time period expired, and reading the RFID tag with the determined radio frequency (RF) power at the channel upon determining the dwell time period not expired.

18. The method of claim 14, wherein the channel comprises at least one of an ultra-high frequency (UHF) channel, a low frequency (LF) channel, or a very high frequency (VHF) channel, and wherein the presence detector comprises at least one of infra-red (IR) sensor, millimeter (MM) wave sensor, microwave sensor, accelerometer, gyroscope, or radar sensor.

19. The method of claim 14 further comprising determining whether the calibration time period is expired, wherein upon determining the calibration time period expired, re-calibrating, via the one or more processors, the RFID reader to determine radio frequency (RF) power.

20. The method of claim 14 further comprising reading another RFID tag with the determined RF power at the channel upon determining the calibration time period not expired.
